(19) United States
(12) Patent Application Publication
(10) Pub. No.: US 2007/0295314 A1
(43) Pub. Date: Dec. 27, 2007

(54) Fuel saving heater for internal combustion engine

(76) Inventor: Naiqiang Dong, Nanjiang (CN)

Correspondence Address: Lan Way, Suite A, 168 S. San Gabriel Blvd., San Gabriel, CA, 91776, US

(21) Appl. No.: 11/899,096

(22) Filed: Sep. 4, 2007

(30) Foreign Application Priority Data
Aug. 23, 2000 (CN) CN 2392923Y

(51) Int. Cl. F02M 27/00

(52) U.S. Cl. 123/538

(57) ABSTRACT

A fuel saving heater, powered by electrical energy from a battery in an automobile, may be disposed at any convenient position preferably as close to the engine of the automobile as possible. The device is operative without any necessary alteration or modification to the original design of the automobile. The device has a housing means that further defines an inner chamber, inlet end, and outlet end. An infrared annular member made of heat retaining materials is disposed in the center portion of the inner chamber. A spirally electrical heating pipe, made of heat conductive materials, wraps firmly around the outside surface of the annular member. Within the heating pipe, there are not only stuffing gauzes with thermally conductive, electrically insulating nature, but also at least two sets of electrical heating elements. The heating elements are to generate sufficient heat to elevate the temperature for the heating pipe, the annular member, and filling metal gauzes stuffed within the inner chamber. All of aforesaid three thermal exchangers are then to elevate the temperature of the fuel via thermal conduction by means of direct contact. Multi-elements plates within the inner chamber are to restore the fuel back to the original stage at refinery level without bad influences of fuel additives. An electrical system including a thermocouple probe to detect the fuel temperature is to precisely control the flow of the electrical current from the battery to the heating elements. A fuel stabilizer is provided to constantly balance the amount and the pressure of the fuel in order to prevent unnecessary fuel waste for the engine. A fuel magnetizer to magnetize the fuel for the purposes of enhancing fuel vaporization and prolonging engine life is also furnished.

### BACKGROUND OF THE INVENTION

1. Field of the Invention

The invention generally relates to an internal combustion engine in an automobile, and specifically to an electrical fuel saving device for heating, catalyzing, stabilizing, and magnetizing the fuel flowing from a fuel tank in the automobile in order to maintain fuel temperature within a predetermined range, improve fuel properties, prevent excessive fuel pressure, and enhance fuel vaporization, and the fuel is then to be delivered to the engine of the automobile for efficient combustion.

2. Description of Prior Art

It is a well-known fact in automobile industry that hydrocarbon fuels such as gasoline and diesel are more efficiently burned for an internal combustion engine if their temperatures can be elevated and maintained within an optimum range than ambient temperatures at various weather conditions prior to intended combustion. To improve the fuel efficiency significantly, many engineers in prior arts have designed numerous devices trying to elevate the temperatures of the fuels above their ambient ones via three types of heat exchange media such as electricity, coolant, or exhaust gas in an automobile. The media of the coolant and the exhaust gas normally need the engine running for a longer time than the electricity medium especially in cold climate to release sufficient heat for the purpose of heating the fuels. Furthermore, both media may sometimes inevitably overheat the fuels to some extent so that the automobile is to be exposed to a great danger of fire or explosion should fuel leakages out of the fuel pipe of the automobile occur in an accident. The electricity seems to be the most feasible and reliable medium to elevate the fuel temperatures for the engine if it is not to cause substantial burden on the battery of the automobile.

Although many heating devices of the prior arts have proved to be operationally efficient in fuel saving for engines of automobiles, these devices definitely have attendant disadvantages in accompanying with the mere advantage of the fuel efficiency. The disadvantages, namely expensive price, bulky size, difficult installation, complex design, hard replacement, and unsafe use, apparently do not thus far justify for their widespread adoptions or usages by either automobile manufacturers or general public.

### OBJECTS OF THE INVENTION

It is a main object of the present invention to provide an improved fuel heating device for an internal combustion engine in an automobile which is efficient in operation, inexpensive in price, compact in size, safe in use, easy in installation, simple in replacement, etc.

It is a further object of the present invention to provide a fuel heating device for the engine which can be readily retrofitted on all types and models of automobiles.

It is a further object of the present invention to provide a fuel heating device for the engine which is capable of accurately maintaining the temperature of the fuel to be delivered to a carburetor or a fuel injector in the automobile within a predetermined range below the boiling point of the fuel but substantially above the ambient temperature at various weather conditions.

It is a further object of the present invention to provide a fuel heating device for the engine which includes a built-in fuel stabilizer capable of regulating the flow and the pressure of the fuel to prevent both from reaching to an excessive or even harmful level.

It is a further object of the present invention to provide a fuel heating device for the engine which includes a built-in fuel magnetizer capable of magnetizing the fuel and improving its properties to prolong engine life, enhance fuel efficiency, and reduce deterioration of fuel delivery parts.

It is a further object of the present invention to provide a fuel heating device, which can be disposed at any convenient position for the fuel pipe between a fuel tank and the carburetor or fuel injector in the automobile, and be utilized by the engine without any alteration or modification to the original design of the automobile.

The invention will be further understood and additional objects and advantages will become apparent from a consideration of the ensuing description and drawings.

### SUMMARY OF THE INVENTION

This invention relates to a fuel heating device in which a housing means defines an inlet end, inner chamber, and outlet end to allow the fuel from a fuel tank in an automobile to be heated and treated, and then be delivered to an internal combustion engine for efficient burning.

In the center portion of the inner chamber, there is an infrared annular member that further defines an interior passageway for some fuel passing through from the inlet end to be heated within. The annular member, made of heat retaining materials, is elongated in shape with its most part in small dimension at size near the inlet end and the remaining part in large dimension at size near the outlet end. On the outside surface of the annular member, there is sintered with a multi-metallic layer. The layer can enhance the temperature stability in the inner chamber by gradually releasing the heat of the annular member slowly. Wrapping around the outside surface of the annular member with, small size, there is a spirally electrical heating pipe that is made of heat conductive materials. Besides the aforementioned annular member and heating pipe, there are still multi-elements plates and filling metal gauzes within the inner chamber. The multi-elements plates may be disposed near the inlet end or the outlet end within the inner chamber. Both of the plates and the aforesaid layer are able to perform a catalysis process to improve the properties of the fuel by restoring the fuel back to the original stage at refinery level without bad influences of fuel additives.

Within the heating pipe, two or more sets of electrical heating elements and stuffing gauzes primarily made of magnesium oxide are provided to generate and conduct sufficient heat to elevate and maintain the temperatures of three thermal exchangers: namely, the heating pipe, the annular member, and the filling gauzes. On the outer surface of the heating pipe, there is sprayed with a nanometer-level ceramic coating to prevent the fuel in direct contact with the surface from overheating. A thermocouple probe is furnished at an advantageous junction of the outlet end within the device to detect the ever-changing fuel temperature. The thermocouple probe is further connected to an integrated circuit and a semiconductor controller on an electrical circuit board. The two electronic instruments are the most important components of the electrical system for the device. The electrical system is able to activate, adjust, and interrupt the electrical current from the battery to the heating elements to prevent the fuel from overheating and unsafe incidents from happening.

A fuel stabilizer, disposed against the inner wall of the inlet end, able to regulate the amount and the pressure of the fuel flowing from the fuel tank in the automobile to a constantly balancing level upon its entering into the device is supplied. A fuel magnetizer, disposed against the inner wall of the outlet end, able to magnetize the fuel for the purpose of vaporization enhancement prior to its exiting out the device is also supplied.

### BRIEF DESCRIPTION OF THE DRAWINGS

Additional objectives, features, and advantages of the present invention will be apparent from the following detailed description and appended claims in conjunction with accompanying drawings, and like reference numerals designate like parts and elements throughout all figures in the drawings, wherein

FIG. 1 is a sectional view of a fuel saving heater showing all principal parts in accordance with the present invention.

FIG. 2 is a sectional view of a fuel stabilizer showing all principal parts in accordance with the present invention.

FIG. 3 is an outline of an electrical system in accordance with the present invention.

FIG. 4 are sectional and perspective views of two different embodiments for a fuel magnetizer and its two principal parts—an inner cylindrical magnetic member and an outer cylindrical magnetic member—in accordance with the present invention.

FIG. 5 are three exploded views of one principal part—a tubular sleeve—for the preferred embodiment of the fuel magnetizer.

FIG. 6 are three exploded views of three principal parts—the inner cylindrical magnetic member, the outer cylindrical magnetic member, and a spacer ring—for the preferred embodiment of the fuel magnetizer

FIG. 7 are orthogonal views of the fuel magnetizer in accordance with the present invention.

FIG. 8 are orthogonal views for the alternative embodiment of the fuel magnetizer.

### DETAILED DESCRIPTION OF THE PREFERRED EMBODIMENT

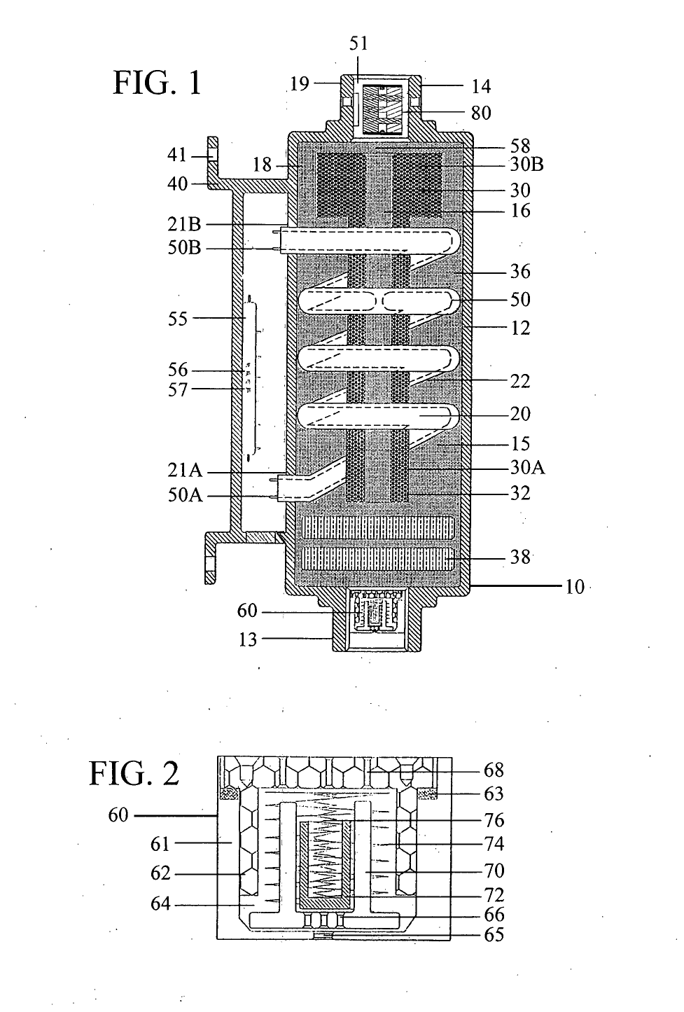

With particular reference to FIG. 1, a fuel heating device 10 in accordance with the preferred embodiment of the present invention comprises of an elongated housing means 12 with an inlet end 13 at its one side and an outlet end 14 at its other side, and a holding base 40 beneath it. The device may be installed on any convenient position in an automobile preferably as close to the internal combustion engine (not shown) of the automobile as possible. The housing means 12 further defines an inner chamber 15 along with the inlet end 13 and the outlet end 14 for establishing a fuel flow path from a fuel tank (not shown) to the engine with the device 10 in between. There is an infrared annular member 30 disposed in the center portion of the inner chamber 15 between the inlet end 13 and the outlet end 14. The annular member 30 elongated in shape can be divided into two different parts. The large part is in small dimension at size 30A with its one side situated near the inlet end 13. The small part is in large dimension at size 30B with its one side situated near the outlet end 14. The annular member 30, made of heat retaining materials, further defines an interior passageway 16 for the fuel passing through it to be elevated in temperature. The housing means 12 mounted on the round base 40 is furthermore fixed securely by a plurality of installation holes 41 on any convenient position between the fuel tank and the engine by means of fastening means (not shown) like screws or bolts. An electrical system has two very important electronic instruments, a semiconductor controller 56 and an integrated circuit 57, and both are mounted on an electrical circuit board 55 on the base 40. The electrical system is able to provide the device 10 with the necessary electrical energy from the battery (not shown) of the automobile.

Wrapping closely and snugly around the outside surface of the annular member 30 with small size 30A, there is a spirally electrical heating pipe 20. The heating pipe 20, made of heat conductive materials, enters into the housing means 12 from an entering position 21A near the inlet end 13 and exits out the housing means 12 from an exiting position 21B near the outlet end 14. The major purpose for the heating pipe 20 to wrap around the annular member 30 spirally in the inner chamber 15 is to provide intended thermal conduction from the heating pipe 20 to the annular member 30. The minor purpose to wrap around the annular member 30 spirally is to hold the annular member 30 in a stable position within the inner chamber 15. Both of the entering position 21A and the exiting position 21B of the heating pipe 20 are fixed and sealed firmly with the housing means 12 by threaded engagements (not shown) to prevent unnecessary fuel leakages. Two or more sets of electrical heating elements 50, made of positive temperature coefficient of resistance materials and regulated by the controller 56 on the circuit board 55, are disposed within the heating pipe 20. Both the heating elements 50 and the controller 56 are connected with the battery to deliver the electrical energy activated by an ignition switch (not shown) of the automobile to the device 10. All sets of the heating elements 50 are adjoined and insulated each other and/or one another all the time within the heating pipe 20 to safely ensure thermal conduction to the outer surface of the heating pipe 20 evenly, uniformly, constantly, and/or continually.

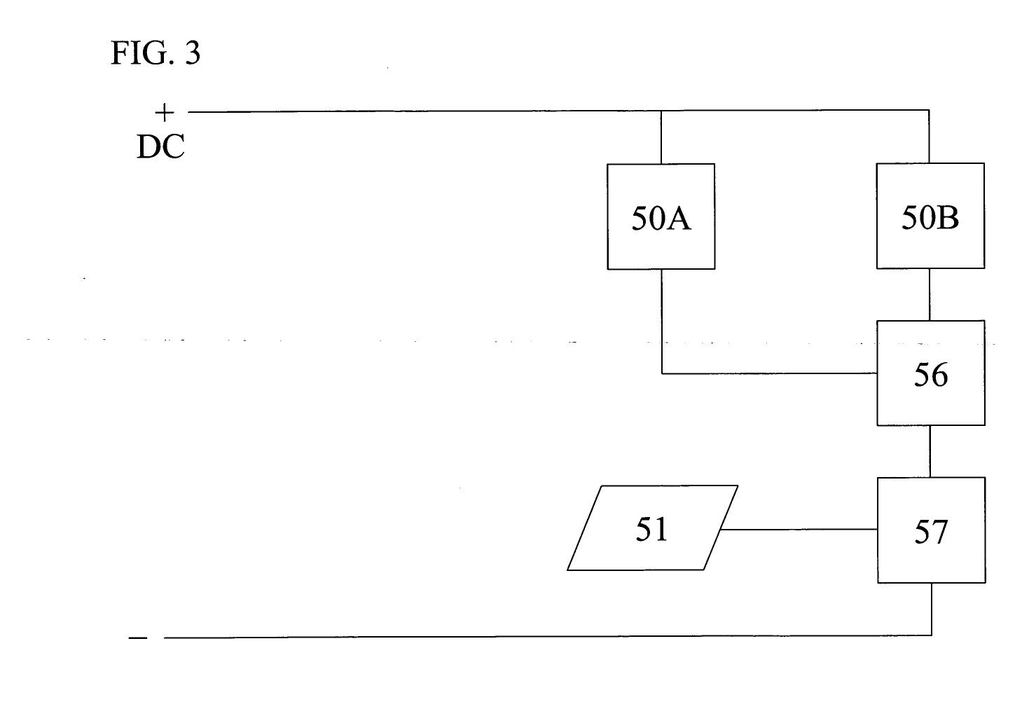

With particular reference to FIGS. 1 and 3, when the ignition switch of the automobile is turned on, a thermocouple probe 51 with two conductor wires enclosed within a sheath (not shown) at an advantageous junction 19 of the outlet end 14 starts to constantly detect the ever-changing temperature of the fuel. There are three main reasons to explain why the temperature of the fuel is ever-changing: the extent of heat generated from the heating elements 50, the extent of heat absorbed by the fuel from thermal exchangers like the heating pipe 20 and the annular member 30, and flow paths of the fuel within the inner chamber 15. There are two flow paths as the fuel enters into the device 10, travels through the inner chamber 15, and exits out the device 10. For both paths, the fuel enters into the device 10 from the inlet end 13 and exits out the device 10 from the outlet end 14. The difference between the two flow paths is the way of how the fuel travels through the inner chamber 15. For one path, the fuel travels through the inner chamber 15 via the interior passageway 16 of the annular member 30. For another path, the fuel travels through the inner chamber 15 via the annular hollow 18 between the annular member 30 and the inner wall of the housing means 12. For the latter fuel, which can be moreover subdivided into the fuel with different directions due to the shape of annular hollow 18, may carry various temperatures because of different extent of heat absorption from thermal conduction. At the area 58 between the annular member 30 and the outlet end 14, all fuel with various temperatures and from different directions converge and blend together to develop into a steady fuel with a specific temperature at any mixing moment. By strategically selecting the advantageous junction 19 at the outlet end 14 to measure the specific temperature of the steady fuel, any wise person may appreciate the measured temperature should rightfully represent the true temperature of the fuel. According to this reasoning, the device 10 intelligently adopts the measured temperature of the fuel at the advantageous junction 19 of the outlet end 14 as the true temperature of the fuel—the yardstick to adequately activate or deactivate the heating elements 50.

The probe 51 often detects a lower fuel temperature at ambient surroundings especially in cold weather than the temperature range predetermined by the optimum combustion for the engine. The probe 51 then converts the true temperature of the fuel into an electronic signal to be sent to the integrated circuit 57. The device 10 under the instruction of the controller 56 is to activate the electrical current throughout all sets of the heating elements 50 in order to elevate the fuel temperature swiftly. As soon as the probe 51 detects any true temperature of the fuel reaching one degree Fahrenheit above the preset optimum range, the device 10 under the instruction of the controller 56 is to deactivate the electrical current throughout all sets of the heating elements 50 except one set to prevent the fuel from overheating. This only set of the heating elements 50A not interrupted by the controller 56 has been continuously working to maintain the fuel temperature within the preset optimum range so long as the engine is turned on. As soon as the probe 51 detects any true temperature of the fuel dropping one degree Fahrenheit below the preset optimum range, the device 10 under the instruction of the controller 56 is to activate the electrical current throughout all other sets of the heating elements 50B to elevate the fuel temperature again. The probe 51, the integrated circuit 57, the controller 56, and the heating elements 50 all work together to constantly and/or continually activate, adjust, or deactivate the electrical current from the battery to an accurate extent in accordance with the true temperature of the fuel detected by the probe 51.

Besides the space occupied by the heating elements 50, there are filled with thermally conductive, electrically insulating stuffing gauzes (not shown) within the heating pipe 20. The stuffing gauzes primarily made of magnesium oxide can hold all sets of the heating elements 50 in firm and stable positions. The stuffing gauzes virtually serve two purposes: one for a thermal conduction medium between the heating elements 50 and the heating pipe 20 and another for electrical insulation among all sets of the heating elements 50. On the outer surface of the heating pipe 20, there is sprayed with a nanometer-level ceramic coating 22 to prevent the fuel in direct contact with the surface from overheating. The ceramic coating 22 practically works to lessen the extent of thermal conduction between the heating pipe 20 and the fuel touching the outer surface for safety concerns. On the outside surface of the annular member 30, there is sintered with a multi-metallic layer 32. The layer 32 can enhance the temperature stability in the inner chamber 15 by gradually releasing the heat of the annular member 30 little by little. The layer 32 also can activate a catalysis process of restoring the fuel back to the original stage at refinery level for efficient combustion before delivery to customers. The reason for the catalysis process to improve the combustion efficiency of the fuel is that all refineries usually add additives to the fuel for numerous reasons like safety, logistics, or antifreeze. Unfortunately, these additives are not helpful or even harmful for the fuel to be burned efficiently in the engine. To further improve the properties of the fuel upon its initial entry into and final exit out the device 10, a plurality of multi-elements plates 38, made of catalysis materials used often by refineries, may be disposed within the inner chamber 15 near the inlet end 13 or the outlet end 14. Likewise to the stuffing gauzes filled within the heating pipe 20 besides the heating elements 50, there are filling metal gauzes 36 stuffed within the inner chamber 15 besides the annular member 30, the heating pipe 20, and the multi-elements plates 38. The filling gauzes 36 not only can absorb the heat diffused from the heating pipe 20 and the annular member 30 to elevate the fuel temperature by means of direct contract, but also can hold the annular member 30 in a stable position within the inner chamber 15.

With particular reference to FIG. 2, a fuel stabilizer 60 to regulate the flow and the pressure of the fuel to a constantly balancing level comprises a cup-shaped inner casing means 61 and a cup-shaped outer casing means 62. Both are made of stiff materials and disposed against the inner wall of the inlet end 13 for the device 10. The cup-shaped inner and outer casing means 61, 62 are clamped 63 together to form an enclosure 64. The inner casing means 61 further has an inlet orifice 65 in its center portion to allow the fuel from the fuel tank to enter into the stabilizer 60. The outer casing means 62 further has a plurality of outlet apertures 68 in its center portion to allow the fuel passing through from the enclosure 64 to enter into the inner chamber 15 of the device 10.

In the enclosure 64, there is a u-shaped large piston 70 whose bottom portion is close and parallel to the inner wall of the inner casing means 61. The large piston 70 has a plurality of inlet apertures 66 in its center portion to allow the fuel passing through from the inlet orifice 65 to enter into the enclosure 64 furthermore. In the meanwhile, these inlet apertures 66 may deny some of the fuel passing through from the inlet orifice 65 to enter into the enclosure 64 furthermore when the large piston 70 is moving toward the inner casing means 61 to block some of the inlet apertures 66. There is a large compression spring 74 disposed and extended between the large piston 70 and the outer casing means 62 in the enclosure 64. Its one side is attached to the inner wall of the large piston 70, whereas its other side to the inner wall of the outer casing means 62. The compression spring 74 is to provide a restraining force to push the large piston 70 toward the inner casing means 61 and then to block the flow of some fuel from the inlet orifice 65 to enter into the enclosure 64 furthermore.

There is also a u-shaped small piston 72 disposed in the pocket of the large piston 70 in the enclosure 64. The bottom portion of the small piston 72 is close and parallel to the bottom portion of the large piston 70. There is a small tension spring 76 disposed and extended between the small piston 72 and the outer casing means 62 in the enclosure 64. Its one side is attached to the inner wall of the outer casing means 62, whereas other side to the inner wall of the small piston 72. The tension spring 76 is to provide a restraining force to push the small piston 72 toward the large piston 70 and then to block the flow of some fuel from the inlet apertures 66 to enter into the enclosure 64 furthermore. The stabilizer 60 fully utilizes both restraining forces from the compression spring 74 and the tension spring 76 in accompanying with the moving function of large piston 70 and small piston 72 to block the flow of some fuel in order to achieve a constantly balancing level for the amount and the pressure of the fuel passing through it.

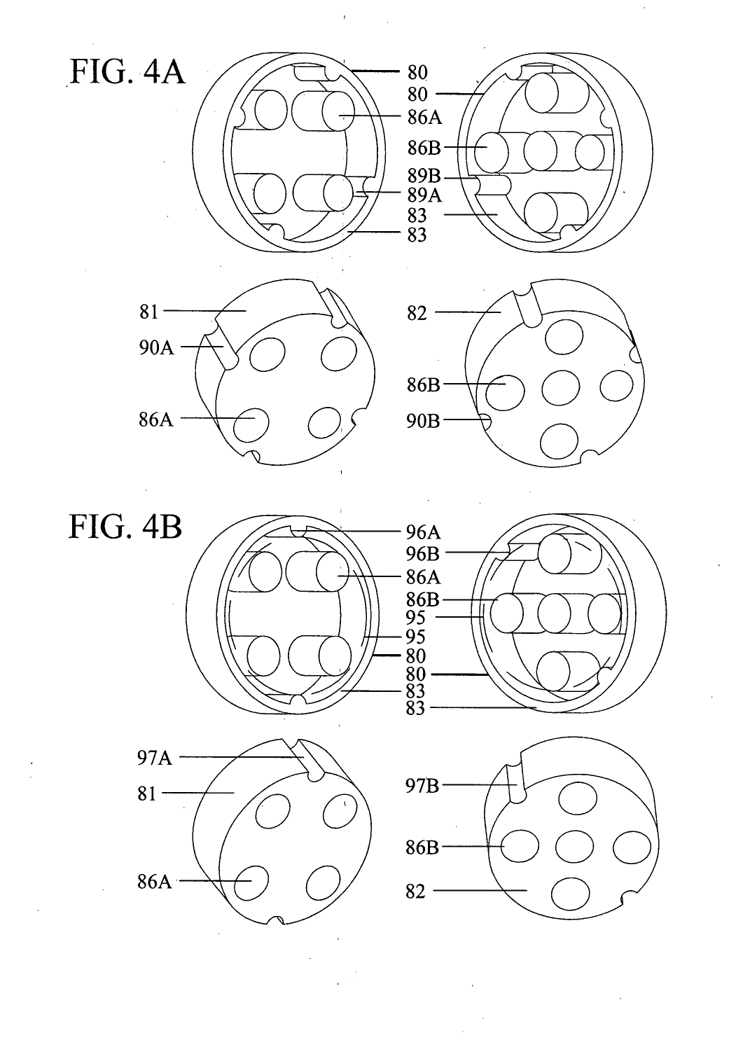

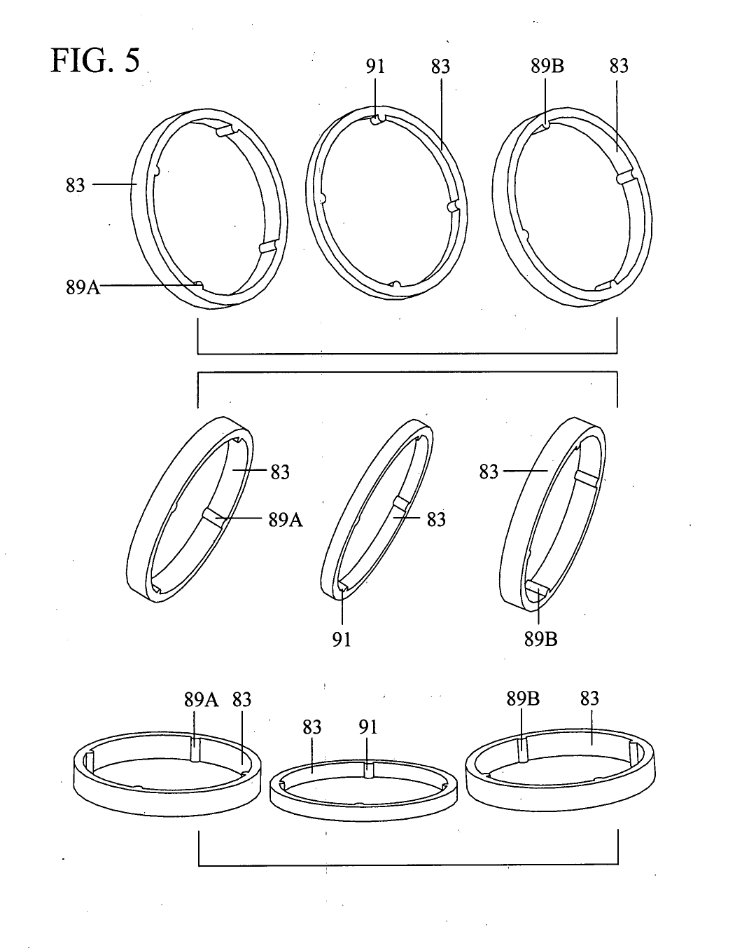

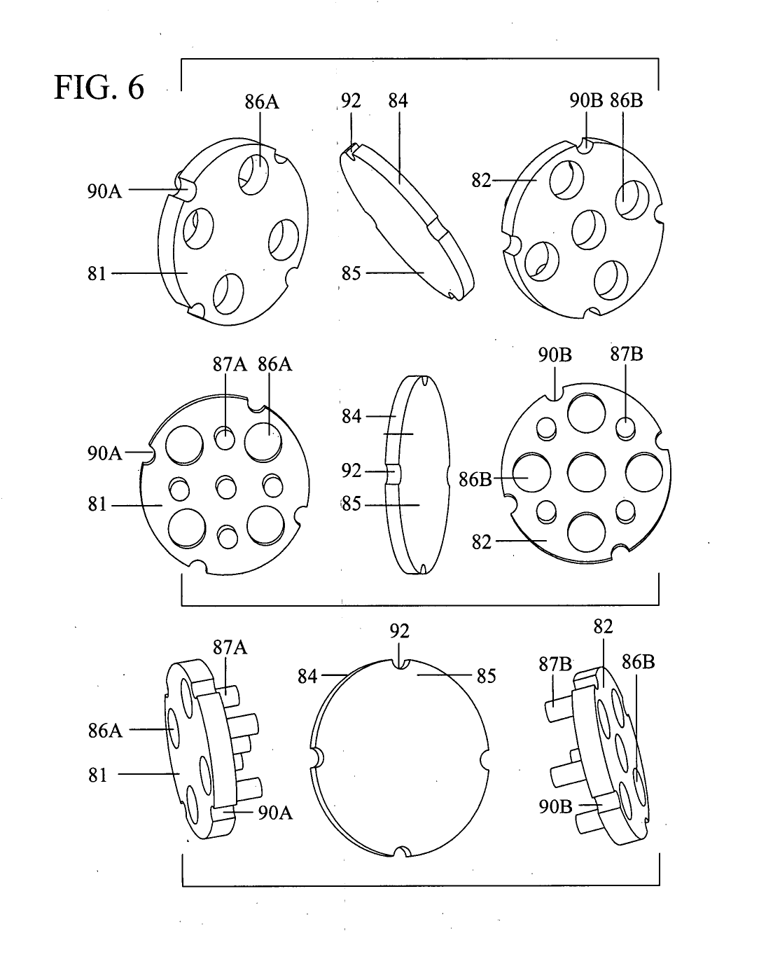

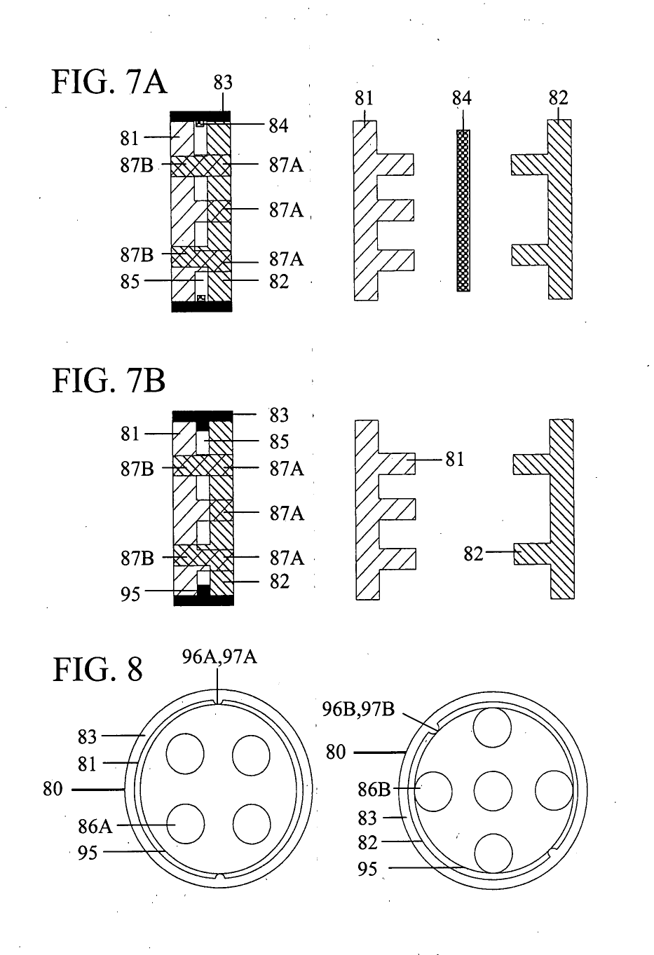

With particular reference to FIGS. 4A, 5, 6, 7A, and 8, a fuel magnetizer 80 to improve fuel properties and to enhance fuel vaporization comprises an outer cylindrical magnetic member 81, an inner cylindrical magnetic member 82, a tubular sleeve 83, and a spacer ring 84. The fuel magnetizer 80 is disposed against the inner wall of the outlet end 14 of the device 10. With regard to the disposition, the inner magnetic member 82 is closer to the annular member 30 than the outer magnetic member 81. Both the magnetic members 81, 82 are made of Nd—Fe—B, whereas the tubular sleeve 83 and spacer ring 84 fuel-resistant materials. The spacer ring 84, having four keyways 92 around its external ring surface, is disposed in the center portion of the fuel magnetizer 80. The spacer ring 84 is to block the two magnetic members 81, 82 and creates a cavity 85 between them. In the center portion of its internal surface, the tubular sleeve 83 has four splines 91 to insert into the respective four keyways 92 of the spacer ring 84. Besides the center portion of its internal surface, the tubular sleeve 83 also has four splines 89A at its one side near the outer magnetic member 81 and four splines 89B at its other side near the inner magnetic member 82.

The inner magnetic member 82 has five round passage holes 86B to allow the fuel to enter into the fuel magnetizer 80 and four cylinder projections 87B to extend into the four round passage holes 86A of the outer magnetic member 81. The outer magnetic member 81 has four round passage holes 86A to allow the fuel to exit out the fuel magnetizer 80 and five cylinder projections 87A to extend into the five round passage holes 86B of the inner magnetic member 82. The identical diameter of each round passage hole 86 in terms of length is exactly twice long as the identical diameter of each cylinder projection 87 for both the magnetic members 81, 82. Each magnetic member 81, 82 has four keyways 90A, 90B around its external cylindrical surface to be inserted into by the respective four splines 89A, 89B of the tubular sleeve 83 correspondingly. The fuel magnetizer 80 utilizes the aforesaid splines 89, 91 and keyways 90, 92 to hold the tubular sleeve 83, the spacer ring 84, and the magnetic members 81, 82 as a cohesive unit.

In an alternative embodiment shown in FIGS. 4B, 7B, and 8, a fuel magnetizer 80 comprises an outer cylindrical magnetic member 81, an inner cylindrical magnetic member 82, and a tubular sleeve 83. The fuel magnetizer 80 is disposed against the inner wall of the outlet end 14 of the device 10. With regard to the disposition, the inner magnetic member 82 is closer to the annular member 30 than the outer magnetic member 81. Both the magnetic members 81, 82 are made of Nd—Fe—B, whereas the tubular sleeve 83 is made of fuel-resistant materials. In the center portion of its internal surface, the tubular sleeve 83 has an attached annulus 95. The annulus 95 is to block the two magnetic members 81, 82 and creates a cavity 85 between them. The annulus 95 is extending from the internal surface of the tubular sleeve 83 into the cavity 85 to separate the outer magnetic member 81 from the inner magnetic member 82. Besides the center portion of its internal surface, the tubular sleeve 83 also has two splines 96A at its one side near the outer magnetic member 81 and two splines 96B at its other side near the inner magnetic member 82.

The inner magnetic member 82 has five round passage holes 86B to allow the fuel to enter into the fuel magnetizer 80 and four cylinder projections 87B to extend into the four round passage holes 86A of the outer magnetic member 81. The outer magnetic member 81 has four round passage holes 86A to allow the fuel to exit out the fuel magnetizer 80 and five cylinder projections 87A to extend into the five round passage holes 86B of the inner magnetic member 82. The identical diameter of each passage hole 86 in terms of length is exactly twice long as the identical diameter of each cylinder projection 87 for both the magnetic members 81, 82. Each magnetic member 81, 82 have two keyways 97A, 97B around its external cylindrical surface to be inserted into by the respective two splines 96A, 96B of the tubular sleeve 83 correspondingly. The fuel magnetizer 80 utilizes the aforesaid splines 96A, 96B and keyways 97A, 97B to hold the tubular sleeve 83 and the magnetic members 81, 82 as a cohesive unit.

### OPERATION OF THE INVENTION

The preferred embodiment of the fuel heating device 10 described and depicted above can be moreover delineated from the standpoint of its operation. When the ignition switch (not shown) of an automobile is turned on, the battery of the automobile is to provide electrical current to all sets of heating elements 50. The heating elements 50, made of heat resistant materials and regulated by a controller 56, are disposed within a spirally electrical heating pipe 20 to avoid direct contact with the fuel from a fuel tank (not shown) for safety reasons. To further prevent the fuel from overheating caused by any direct contact, there is a ceramic coating 22 sprayed on the outer surface of the heating pipe 20. The heating pipe 20, made of heat conductive materials, enters into a housing means 12 from its one position 21A and exits out the housing means from its other position 21B. The heating elements 50 are to swiftly elevate the temperature of the heating pipe 20 first and then in turn to elevate ones of an infrared annular member 30 and filling metal gauzes 36 via thermal conduction within an inner chamber 15 defined by the housing means 12. The fuel at ambient temperature furnished by a fuel pump (not shown) flows into the device 10 from an inlet end 13. The temperature of the fuel is to be elevated by the heating pipe 20, the annular member 30, and the filling gauzes 36 within the inner chamber 15 by means of thermal conduction while the fuel is passing through the device 10.

Before the fuel finally exits out the device 10 from an outlet end 14, there is a thermocouple probe 51 to detect the ever-changing, true temperature of the fuel. Should the temperature of the fuel is above or below a preset optimum range, an electronic signal from the probe 51 is sent to an integrated circuit 57 and a semiconductor controller 56 on an electrical circuit board 55. The device 10 under the instruction of the controller 56 on the circuit board 55 is to activate, adjust, or deactivate electrical current to all sets of the heating elements 50 except one set. This very set of the heating elements 50A is to be continuously working to prevent the fuel temperature dropping below the preset optimum range as long as the engine is turned on. The device 10, able to elevate and maintain the fuel temperature accurately and safely within the preset optimum range, consequently results into two favorable effects: the improvement in fuel efficiency and the reduction in emitting pollutants.

The device 10 is also able to improve the properties of the fuel furthermore by providing a multi-metallic layer 32 on the outside surface of the annular member 30 and multi-elements plates 38 within the inner chamber 15. Both are capable of restoring the fuel back to the original stage at refinery level for the efficient combustion in the engine. The device 10 also provides a fuel stabilizer 60 to regulate the amount and the pressure of the fuel to a constantly balancing level to avoid any unnecessary fuel waste in the combustion chambers of the engine. The device 10 finally furnishes a fuel magnetizer 80 to improve fuel properties and enhance fuel vaporization by means of Nd—Fe—B permanent magnet.

Accordingly, while this invention has been described with reference to the illustrative embodiment, none should intend to interpret the description in a limiting or narrow sense regarding its scope. Various ramifications, variations, and modifications of the illustrative embodiment will be apparent to those people skilled in the art upon reference to the description. It is therefore contemplated that the appended claims and their legal equivalents will cover any aforesaid ramifications, variations, and modifications within the true scope of the invention.

I claim:

1. A fuel magnetizer to improve and enhance the properties and vaporization of a fuel for an internal combustion engine in an automobile, comprising:
a) an outer cylindrical magnetic member having a plurality of keyways around its external cylindrical surface and an inner cylindrical magnetic member having a plurality of keyways around its external cylindrical surface and both made of Nd—Fe—B permanent magnet, said inner magnetic member defining a plurality of round passage holes to allow said fuel to enter into said fuel magnetizer and said outer magnetic member defining a plurality of round passage holes to allow said fuel to exit out said fuel magnetizer, said inner magnetic member further defining a plurality of cylinder projections to extend into corresponding said passage holes of said outer magnetic member to create magnetic fields within said passage holes, said outer magnetic member further defining a plurality of cylinder projections to extend into corresponding said passage holes of said inner magnetic member to create magnetic fields within said passage holes;
b) a tubular sleeve made of fuel-resistant materials having a plurality of splines over the center portion of its internal surface, a plurality of splines over the one side of said internal surface to insert into respective said keyways of said outer magnetic member, and a plurality of splines over the other side of said internal, surface to insert into respective said keyways of said inner magnetic member;
c) a spacer ring made of said fuel-resistant materials defining a cavity between said outer magnetic member and said inner magnetic member to create a magnetic field within said cavity, said spacer ring further having a plurality of keyways around its external ring surface to allow respective said center splines of said tubular sleeve to insert into; and
d) said cavity providing excessive fuel flowing from said inner magnetic member to be accumulated and to be treated there by a magnetic field generated by said Nd—Fe—B prior to entrance into said outer magnetic member.
Whereby said magnetic fields within said passage holes of said inner magnetic member, said cavity, and said passage holes of said outer magnetic member develop a magnetic flow path throughout entire said fuel magnetizer for said fuel to be magnetized in order to obtain desirable goals such as prolongation of engine life, enhancement of fuel efficiency, and reduction of deterioration of fuel delivery parts.

2. A fuel magnetizer to improve and enhance the properties and vaporization of a fuel for an internal combustion engine in an automobile, comprising:
a) an outer cylindrical magnetic member having a plurality of keyways around its external cylindrical surface and an inner cylindrical magnetic member having a plurality of keyways around its external cylindrical surface and both made of Nd—Fe—B permanent magnet, said inner magnetic member defining a plurality of round passage holes to allow said fuel to enter into said fuel magnetizer and said outer magnetic member defining a plurality of round passage holes to allow said fuel to exit out said fuel magnetizer, said inner magnetic member further defining a plurality of cylinder projections to extend into corresponding said passage holes of said outer magnetic member to create magnetic fields within said passage holes, said outer magnetic member further defining a plurality of cylinder projections to extend into corresponding said passage holes of said inner magnetic member to create magnetic fields within said passage holes;
b) a tubular sleeve made of fuel-resistant materials having an attached annulus over the center portion of its internal surface, having a plurality of splines over the one side of said internal surface to insert into respective said keyways of said outer magnetic member, and having a plurality of splines over the other side of said internal surface to insert into respective said keyways of said inner magnetic member, said annulus further defining a cavity between said outer magnetic member and said inner magnetic member to create a magnetic field within said cavity; and
c) said cavity providing excessive fuel flowing from said inner magnetic member to be accumulated and to be treated there by a magnetic field generated by said Nd—Fe—B prior to entrance into said outer magnetic member.
Whereby said magnetic fields within said passage holes of said inner magnetic member, said cavity, and said passage holes of said outer magnetic member develop a magnetic flow path throughout entire said fuel magnetizer for said fuel to be magnetized in order to obtain desirable goals such as prolongation of engine life, enhancement of fuel efficiency, and reduction of deterioration of fuel delivery parts.

3. A method of treating the fuel flowing from a fuel tank of an automobile prior to its entrance into the combustion chambers of an internal combustion engine in said automobile by means of a fuel stabilizer, multi-elements plates, thermal exchangers, a fuel magnetizer, and a thermocouple probe, comprising the following steps of:
a) first stabilizing the amount and the pressure of said fuel to a constantly balancing level by using said fuel stabilizer;
b) second activating the catalysis process of restoring said fuel back to the original stage at refinery level by using said multi-elements plates;
c) then elevating and maintaining the temperature of said fuel evenly, uniformly, constantly, and/or continually by using said thermal exchangers;
d) subsequently magnetizing and improving the functional properties of said fuel by using said fuel magnetizer; and
e) finally detecting and monitoring constantly the ever-changing temperature of said fuel by using said thermocouple probe.
Whereby said fuel can be burned more efficiently and effectively by said engine in said automobile to accomplish twofold goals of fuel conservation and environment preservation.

4. The method of evenly and uniformly elevating the temperature of the fuel of claim 3, further comprising the following steps of:
a) elevating said temperature of said fuel to the maximum extent throughout thermal conduction by means of direct contact with the two components, the heating pipe and the annular member, of said thermal exchangers;
b) elevating said temperature of said fuel to the next maximum extent throughout thermal conduction by means of direct contact with the interior passageway of said annular member of said thermal exchangers;
c) elevating said temperature of said fuel to the minimum extent throughout thermal conduction by means of direct contact solely with another component, the filling metal gauzes, of said thermal exchangers; and
d) elevating said temperature of said fuel to the medium extent throughout thermal conduction by means of direct contact with said three components of said thermal exchangers in a variety of ways or other combinations other than above-mentioned said three steps.

5. The method of evenly and uniformly elevating the temperature of the fuel of claim 4, further comprising the following steps of:
a) elevating said temperature of said heating pipe evenly and uniformly throughout thermal conduction by providing two or more sets of heating elements, adjoined each other and/or one another, within said heating pipe;
b) elevating said temperature of said heating pipe evenly and uniformly throughout thermal conduction by providing thermally conductive, electrically insulating stuffing gauzes within said heating pipe;
c) elevating said temperature of said annular member evenly and uniformly throughout thermal conduction by providing the outside surface of said annular member with a spirally wrapping said heating pipe around it;
d) elevating said temperature of said filling metal gauzes evenly and uniformly throughout thermal conduction by providing direct or indirect contact with said heating pipe and said annular member within the inner chamber of this invented device; and
e) elevating said temperature of said fuel evenly and uniformly throughout direct contact with said three components of said thermal exchangers such as said heating pipe, said annular member, and said filling metal gauzes within said inner chamber.

6. The method of evenly and uniformly maintaining the temperature of the fuel of claim 3, further including the step of blending all said fuel with various temperatures and from different directions into a steady fuel with an ever-changing specific temperature at the mixing moment and at the area between the annular member and the outlet end of this invented device.

7. The method of evenly and uniformly maintaining the temperature of the fuel of claim 3 and 6, further comprising the two steps of strategically selecting an advantageous junction at said outlet end for said thermocouple probe to properly measure said specific temperature of said steady fuel at said advantageous junction of said outlet end that is rightfully representing the true temperature of said fuel for said device, and intelligently adopting said true temperature of said fuel as the yardstick for the controller of said device to adequately activate or deactivate the heating elements of said device.

8. The method of detecting and monitoring constantly the specific temperature of the steady fuel at the advantageous junction of the outlet end of claim 3, 6, and 7, further comprising the following steps of:
a) constantly detecting said specific temperature of said steady fuel at said advantageous junction of said outlet end throughout direct contact with said steady fuel via said thermocouple probe to constantly convert said specific temperature of said steady fuel into an electronic signal to be sent to the integrated circuit of said device;
b) constantly monitoring said specific temperature of said steady fuel at said advantageous junction of said outlet end throughout direct contact with said steady fuel via said thermocouple probe and with the help from said integrated circuit to determine whether said specific temperature of said steady fuel is above or below the predetermined temperature range for said device or not; and
c) constantly repeating above-mentioned said two steps via said thermocouple probe, said integrated circuit, and said controller as long as said engine of said automobile is turned on.

9. The method of constantly maintaining the specific temperature of the steady fuel at the advantageous junction of the outlet end of claim 3, 6, 7, and 8, further comprising the following steps of:
a) activating swiftly the heating elements of said device by said controller if any said specific temperature of said steady fuel at said advantageous junction of said outlet end is below said predetermined temperature range;
b) deactivating swiftly said heating elements by said controller if any said specific temperature of said steady fuel at said advantageous junction of said outlet end is above said predetermined temperature range; and
c) repeating continually said activating and deactivating steps as long as said engine of said automobile is turned on.

10. The method of evenly and uniformly elevating the temperature of the fuel by providing the heating pipe with two or more sets of the heating elements of claim 3, 4, and 5, further comprising the following steps of:
a) actuating rapidly all sets of said heating elements as soon as said engine of said automobile is started;
b) deactivating swiftly said all sets of said heating elements but one set to maintain said temperature of said fuel within the predetermined temperature range for said device if said temperature of said fuel is above said predetermined temperature range;
c) activating swiftly the other sets of said heating elements to elevate said temperature of said fuel again if said temperature of said fuel is below said predetermined temperature range; and
d) repeating continually said deactivating and activating steps to elevate or to lower said temperature of said fuel as long as said engine of said automobile is turned on.

11. The method of constantly and/or continually detecting, monitoring, elevating, and maintaining the specific temperature of the steady fuel at the advantageous junction of the outlet end of claim 3, 4, 5, 6, 7, 8, 9, and 10, further comprising the following steps of:
a) actuating rapidly said all sets of said heating elements as soon as said engine of said automobile is started;
b) detecting constantly said specific temperature of said steady fuel at said advantageous junction of said outlet end throughout direct contact with said steady fuel via said thermocouple probe to constantly convert said specific temperature of said steady fuel into an electronic signal to be sent to said integrated circuit;
c) monitoring constantly said specific temperature of said steady fuel at said advantageous junction of said outlet end throughout direct contact with said steady fuel via said thermocouple probe and with the help from said integrated circuit to determine whether said specific temperature of said steady fuel is above or below said predetermined temperature range or not;
d) deactivating swiftly said other sets of said heating elements by said controller if said thermocouple probe detects any said specific temperature of said steady fuel at said advantageous junction of said outlet end above said predetermined temperature range;
e) activating swiftly said other sets of said heating elements by said controller if said thermocouple probe detects any said specific temperature of said steady fuel at said advantageous junction of said outlet end below said predetermined temperature range;
f) elevating continually said specific temperature of said steady fuel at said advantageous junction of said outlet end by means of activating swiftly said other sets of said heating elements by said controller until said thermocouple probe detects any said specific temperature of said steady fuel above said predetermined temperature range; and
g) repeating continually said deactivating, activating, and elevating steps by said controller to elevate or lower said specific temperature of said steady fuel as long as said engine of said automobile is turned on.
